(19) United States
(12) Patent Application Publication
(10) Pub. No.: US 2008/0113238 A1
(43) Pub. Date: May 15, 2008

(54) FUEL CELL SYSTEM AND TRANSPORTATION EQUIPMENT INCLUDING THE SAME

(75) Inventors: Takashi Ito, Shizuoka (JP); Arato Takahashi, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: YAMAHA HATSUDOKI KABUSHIKI KAISHA, Iwata-shi (JP)

(21) Appl. No.: 11/936,932

(22) Filed: Nov. 8, 2007

(30) Foreign Application Priority Data
Nov. 10, 2006 (JP) 2006-305569

(51) Int. Cl. H01M 8/04

(52) U.S. Cl. 429/24; 429/22

(57) ABSTRACT

A fuel cell system capable of reducing concentration change in an aqueous fuel solution and transportation equipment including the system such as a motorbike includes such a fuel cell system. The fuel cell system includes a cell stack, an aqueous solution tank which holds aqueous methanol solution to be supplied to the cell stack, a fuel tank which holds methanol fuel, a water tank which holds water, a fuel pump which supplies the aqueous solution tank with methanol fuel in the fuel tank, a water pump which supplies the aqueous solution tank with water in the water tank, and a CPU which controls the fuel cell system. The CPU obtains an amount of water supplied to the aqueous solution tank by using a drive time and output of the water pump, and controls the fuel pump so as to supply the aqueous solution tank with methanol fuel according to the supplied amount of water.

### BACKGROUND OF THE INVENTION

1. Field of the Invention

The present invention relates to fuel cell systems and transportation equipment including the system, and more specifically, to a fuel cell system which holds aqueous fuel solution, and transportation equipment including the system.

2. Description of the Related Art

Generally, in fuel cell systems in which aqueous fuel solution is supplied directly to the fuel cell, it is known to add water to an aqueous solution container which holds the aqueous fuel solution in order to maintain a predetermined amount of liquid in the aqueous solution container.

WO 2004/030134 discloses a fuel cell system in which aqueous fuel solution is supplied directly to the fuel cell, the concentration of the aqueous fuel solution is detected by using an open-circuit voltage of the fuel cell, and the concentration of the aqueous fuel solution is controlled based on a result of the detection.

Normally, chemical changes in the aqueous fuel solution are slower when the temperature is lower. Therefore, the open-circuit voltage difference between two different concentrations is smaller when the temperature of the aqueous fuel solution is lower. When power generation in the fuel cell is stopped, protons resulting from reactions at the anode do not react with oxygen, and therefore accumulate. When power generation is started, the accumulated protons react with oxygen rapidly making the open-circuit voltage unstable.

For these reasons, the results of detecting the concentration are not very reliable for the period of time when the temperature of the aqueous fuel solution is low or for a period of time after power generation is started, and during this period it is impossible to adjust the concentration appropriately. If water is supplied under such a condition to the aqueous solution container in order to maintain the amount of liquid at a predetermined level, a problem arises that the concentration of the aqueous fuel solution is changed drastically. WO 2004/030134 does not disclose how the concentration is detected and adjusted when the temperature of aqueous fuel solution is low (see FIG. 2 of WO 2004/030134) or when power generation is started.

### SUMMARY OF THE INVENTION

In order to overcome the problems described above, preferred embodiments of the present invention provide a fuel cell system capable of reducing changes in the concentration of the aqueous fuel solution, and provide transportation equipment including the system.

According to another preferred embodiment of the present invention, a fuel cell system includes a fuel cell, an aqueous solution container arranged to hold and supply the aqueous fuel solution to the fuel cell, a water supplying device arranged to supply the aqueous solution container with water, a fuel supplying device arranged to supply the aqueous solution container with fuel, a water supply amount obtaining device arranged to obtain data regarding the amount of water supplied by the water supplying device to the aqueous solution container, and a controller arranged to control the fuel supplying device based on the data regarding the supplied amount of water obtained by the water supply amount obtaining device.

According to another preferred embodiment of the present invention, the controller controls the fuel supplying device so that an amount of fuel according to the supplied amount of water is supplied to the aqueous solution container. By supplying the aqueous solution container with fuel according to the supplied amount of water as described, it becomes possible to reduce the concentration change in the aqueous fuel solution associated with the supplied amount of water even when it is not possible to appropriately adjust the concentration of the aqueous fuel solution.

Preferably, the fuel cell system further includes a first fuel-supply amount obtaining device arrange to obtain data regarding the supplied amount of fuel to the aqueous solution container based on the data regarding the supplied amount of water obtained by the water supply amount obtaining device. The controller controls the fuel supplying device based on the data regarding the supplied amount of fuel obtained by the first fuel-supply amount obtaining device. In this case, the first fuel-supply amount obtaining device obtains data regarding the supplied amount of the fuel according to the supplied amount of water, and the controller controls the fuel supplying device based on the data regarding the supplied amount of the fuel. This makes it possible to supply the aqueous solution container with an appropriate amount of fuel.

Further, preferably, the fuel cell system further includes a second fuel-supply amount obtaining device arranged to obtain data regarding the supplied amount of fuel to the aqueous solution container based on information regarding the concentration of the aqueous fuel solution. The controller controls the fuel supplying device based on the data regarding the supplied amount of fuel obtained by the first fuel-supply amount obtaining device and the data regarding the supplied amount of fuel obtained by the second fuel-supply amount obtaining device. In this case, the second fuel-supply amount obtaining device obtains the data regarding the supplied amount of fuel based on information regarding the concentration of the aqueous fuel solution. Then, the controller controls the fuel supplying device based on the data regarding the supplied amount of the fuel obtained respectively by the first and the second fuel-supply amount obtaining devices. This also makes it possible to supply the aqueous solution container with fuel according to the amount of fuel consumption, etc., in the fuel cell, and thereby to bring the concentration of the aqueous fuel solution which is to be supplied to the fuel cell close to a desired concentration.

The information regarding the concentration may be a result of detecting the concentration by a detector or a result of calculation of, e.g., the amount of fuel consumption.

Further, preferably, the fuel cell system further includes a concentration detector arranged to detect a concentration of the aqueous fuel solution, and a determination device arranged to determine whether or not a result of detection by the concentration detector is reliable. The second fuel-supply amount obtaining device obtains the data regarding the supplied amount of fuel based on a result of detection by the concentration detector if the determination device determines that the result of detection by the concentration detector is reliable. As described, the second fuel-supply amount obtaining device obtains data regarding the supplied amount of fuel based on a result of detection by the concentration detector if a result of detection by the concentration detector is reliable, whereby it becomes possible to reduce the concentration change associated with fuel consumption in the fuel cell and the concentration change associated with crossover and evaporation, etc., and therefore more reliably bring the concentration of the aqueous fuel solution which is to be supplied to the fuel cell close to a desired concentration.

Preferably, the fuel cell system further includes a consumption amount obtaining device arranged to obtain a consumption amount of the fuel in the fuel cell. The second fuel-supply amount obtaining device obtains the data regarding the supplied amount of fuel based on a consumption amount of the fuel obtained by the consumption amount obtaining device if the determination device determines that the result of detection by the concentration detector is not reliable. This arrangement makes it possible to reduce the concentration change associated with the water supply and the concentration change associated with fuel consumption in the fuel cell, and therefore more reliably reduce the concentration change in the aqueous fuel solution, even if it is not possible to obtain data regarding the supplied amount of fuel based on a result of detection by the concentration detector.

Further, preferably, the fuel cell system further includes a temperature detector arranged to detect a temperature of the aqueous fuel solution, and a time measuring device arranged to measure a time from a start of power generation in the fuel cell. The determination device determines whether or not a result of detection by the concentration detector is reliable based on a result of detection by the temperature detector and a result of time measurement by the time measuring device. In this case, it becomes easy to determine whether or not a result of detection by the concentration detector is reliable based on the temperature of the aqueous fuel solution detected by the temperature detector and the time from the start of power generation in the fuel cell measured by the time measurement device.

Further, preferably, the water supplied by the water supplying device to the aqueous solution container is produced by an electrochemical reaction in the fuel cell. By supplying water which is produced by the electrochemical reaction in the fuel cell to the aqueous solution container as described, it becomes possible to replenish water within the system without supplying water externally.

Preferably, the fuel cell system further includes a water container arranged to hold water from the fuel cell. The water supplying device supplies the aqueous solution container with water held in the water container. In the present fuel cell system, water and exhaust gas from the fuel cell are introduced into the water container. Then, out of the water and the exhaust gas which are introduced into the water container, the water is held in the water container while the exhaust gas is discharged. With such an arrangement, water which is held in the water container is supplied to the aqueous solution container by the water supplying device whereby it becomes possible to supply water more efficiently to the aqueous solution container than in a case where the water and the exhaust gas are supplied directly from the fuel cell to the aqueous solution container. Also, holding the water in the water container makes it easy to supply only water to the aqueous solution container, making it possible to obtain the amount of water supplied to the aqueous solution container more accurately than in a case where water and exhaust gas are supplied directly from the fuel cell to the aqueous solution container.

Further, preferably, the data regarding the supplied amount of the water includes a drive time of the water supplying device. By using the drive time of the water supplying device, it is possible to obtain data regarding the supplied amount of water to the aqueous solution container easily and accurately.

Further, preferably, the fuel cell system includes a first liquid amount detector arranged to detect an amount of liquid in the aqueous solution container. The water supply amount obtaining device obtains the data regarding the supplied amount of water based on a result of detection by the first liquid amount detector. In this case, it is possible to obtain an amount of liquid in the aqueous solution container before the water is supplied and an amount of liquid in the aqueous solution container after the water is supplied, and to use a difference between these as the amount of water supplied to the aqueous solution container. By using the amount of increase in the amount of liquid held in the aqueous solution container associated with the supply of water as the supplied amount of water as described, it becomes possible to obtain the supplied amount of water more accurately.

Preferably, the first liquid amount detector detects the amount of liquid in the aqueous solution container based on a height of the liquid surface in the aqueous solution container. Fuel cell systems in which aqueous fuel solution is circulated to the fuel cell, and fuel cell systems in which water is supplied to the aqueous solution container in order to maintain the amount of liquid in the aqueous solution container at a predetermined level are already known. In such a fuel cell system, the aqueous solution container is supplied with gases, such as carbon dioxide produced during power generation, in association with the return flow of aqueous fuel solution and so on during power generation, and this produces bubbles in the aqueous fuel solution in the aqueous solution container. If the amount of liquid in the aqueous solution container is detected based on the liquid level in the aqueous solution container, liquid levels detected during power generation are levels of the aqueous fuel solution which contains the bubbles. For this reason, during power generation, the system determines that the amount of liquid in the aqueous solution container is at a predetermined amount even if the actual amount of liquid is lower than the predetermined amount. The bubbles disappear after power generation is stopped. When the system is started the next time, therefore, the system determines that the amount of liquid in the aqueous solution container is lower than the predetermined amount, and supplies a large amount of water to the aqueous solution container to bring the amount of liquid to the predetermined amount. In this case, the concentration change in aqueous fuel solution is extraordinarily large. Preferred embodiments of the present invention are capable of supplying the aqueous solution container with fuel according to the supplied amount of water. Therefore, it is possible to reliably reduce the concentration change in the aqueous fuel solution even if a large amount of water is supplied to the aqueous solution container due to the use of the first liquid-amount detector which detects the amount of liquid based on the height of the liquid surface.

Preferably, the fuel cell system further includes a second liquid amount detector arranged to detect an amount of liquid in the water container. The water supply amount obtaining device obtains data regarding the supplied amount of water based on a result of detection by the second liquid amount detector. In this case, the second liquid amount detector detects an amount of liquid in the water container before the water is supplied and an amount of liquid in the water container after the water is supplied, and it is possible for the water supply amount obtaining device to obtain a difference between these as the amount of water supplied to the aqueous solution container. By using the amount of decrease in the amount of liquid held in the water container associated with the supply of water as the supplied amount of water to the aqueous solution container as described, it becomes possible to obtain the supplied amount of water more accurately.

Further, preferably, the fuel cell system includes a first liquid amount detector arranged to detect an amount of the liquid in the aqueous solution container. The controller controls the water supplying device so as to supply water when a result of detection by the first liquid amount detector is lower than a first predetermined amount, and controls the fuel supplying device based on the data regarding the supplied amount of the water when the result of detection by the first liquid amount detector is lower than the first predetermined amount. In this case, water is supplied within a range that the amount of liquid in the aqueous solution container does not exceed the first predetermined amount, and fuel is supplied according to the supplied amount of water. Therefore, it is possible to bring the amount of aqueous solution in the aqueous solution container to an appropriate level, and to perform accurate concentration control.

Preferably, the fuel cell system further includes a water container arranged to hold water from the fuel cell, and a second liquid amount detector arranged to detect an amount of liquid in the water container. The controller controls the water supplying device so as to supply water when a result of detection by the first liquid amount detector is lower than the first predetermined amount and a result of detection by the second liquid amount detector is not lower than a second predetermined amount. In this case, it is possible to stop supplying water when the amount of liquid in the water container becomes lower than the second predetermined amount. Therefore, it is possible to prevent the water supplying device such as a water pump from running dry without water, as well as to accurately obtain the supplied amount of water.

Desirably, transportation equipment should be able to run stably. Since the fuel cell system according to preferred embodiments of the present invention is capable of reducing concentration changes in the aqueous methanol solution, it is capable of stabilizing the fuel cell's output, and driving the system components, i.e., the transportation equipment stably. Therefore, the fuel cell system according to preferred embodiments of the present invention can be used suitably for transportation equipment.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a left side view of a motorbike according to a preferred embodiment of the present invention.

FIG. 2 is a system diagram showing piping in a fuel cell system according to a preferred embodiment of the present invention.

FIG. 3 is a block diagram showing an electric configuration of the fuel cell system according to a preferred embodiment of the present invention.

FIG. 4 is a flowchart showing an example of the operation of the fuel cell system according to a preferred embodiment of the present invention.

FIG. 5 is a graph showing timecourse changes of output, etc., in a comparative example, in a case where power generation was started when the aqueous methanol solution was at a temperature close to ambient temperature.

FIG. 6 is a graph showing timecourse changes of output, etc., in a fuel cell system according to a preferred embodiment of the present invention, in a case where power generation was started when the aqueous methanol solution was at a temperature close to ambient temperature.

FIG. 7 is a graph showing timecourse changes of output, etc., in the comparative example, in a case where power generation was started when the aqueous methanol solution was warm.

FIG. 8 is a graph showing timecourse changes of output, etc., in a fuel cell system according to a preferred embodiment of the present invention, where power generation was started when the aqueous methanol solution was warm.

FIG. 9 is a system diagram showing piping in another preferred embodiment of the fuel cell system of the present invention.

FIG. 10 is a flowchart showing an example of the operation of another preferred embodiment of the fuel cell system of the present invention.

### DETAILED DESCRIPTION OF PREFERRED EMBODIMENTS

Hereinafter, preferred embodiments of the present invention will be described with reference to the drawings.

The preferred embodiments described below refer to a fuel cell system 100 provided in a motorbike 10 as an example of the transportation equipment.

The description will first cover a motorbike 10. It is noted that the terms left and right, front and rear, up and down as used in the preferred embodiments of the present invention are determined from the normal state of riding, i.e., as viewed by the driver sitting on the driver's seat of the motorbike 10, with the driver facing toward a handle 24.

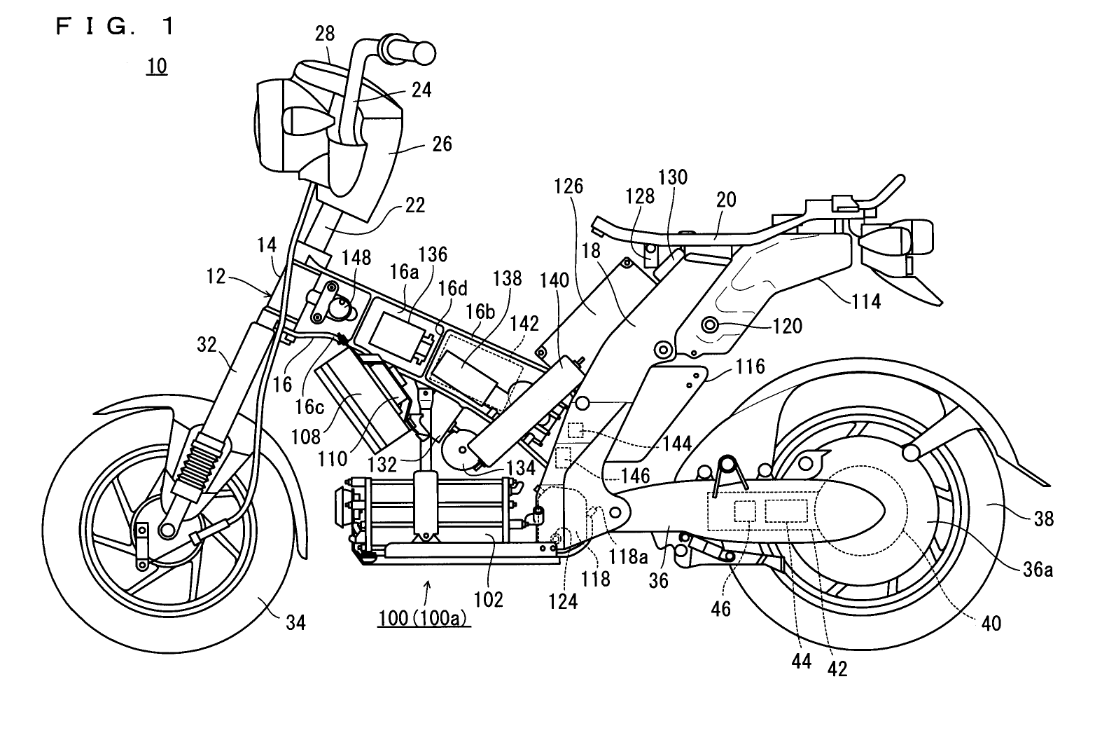

Referring to FIG. 1, the motorbike 10 preferably includes a vehicle frame 12. The vehicle frame 12 has a head pipe 14, a front frame 16 which has an I-shaped vertical section and extends in a rearward and downward direction from the head pipe 14, and a rear frame 18 which is connected with a rear end of the front frame 16 and rising in a rearward and upward direction.

The front frame 16 preferably includes a plate member 16a which has a width in the vertical direction and extends in a rearward and downward direction substantially perpendicularly to the lateral directions of the vehicle; flanges 16b, 16c which are located respectively at an upper end edge and a lower end edge of the plate member 16a, and extending in a rearward and downward direction and have a width in the lateral directions; and reinforcing ribs 16d protruding from both surfaces of the plate member 16a. The reinforcing ribs 16d and the flanges 16b, 16c define storage walls, providing compartments on both surfaces of the plate member 16a which define storage spaces for components of the fuel cell system 100 to be described later.

The rear frame 18 preferably includes a pair of left and right plate members each having a width in the front and rear directions, extending in a rearward and upward direction, and sandwiching a rear end of the front frame 16. The pair of plate members of the rear frame 18 have their upper end portions provided with seat rails 20 fixed thereto for installation of an unillustrated seat. Note that FIG. 1 shows the left plate member of the rear frame 18.

A steering shaft 22 is pivotably inserted in the head pipe 14. A handle support 26 is provided at an upper end of the steering shaft 22, to which a handle 24 is fixed. The handle support 26 has an upper end provided with a display/operation board 28.

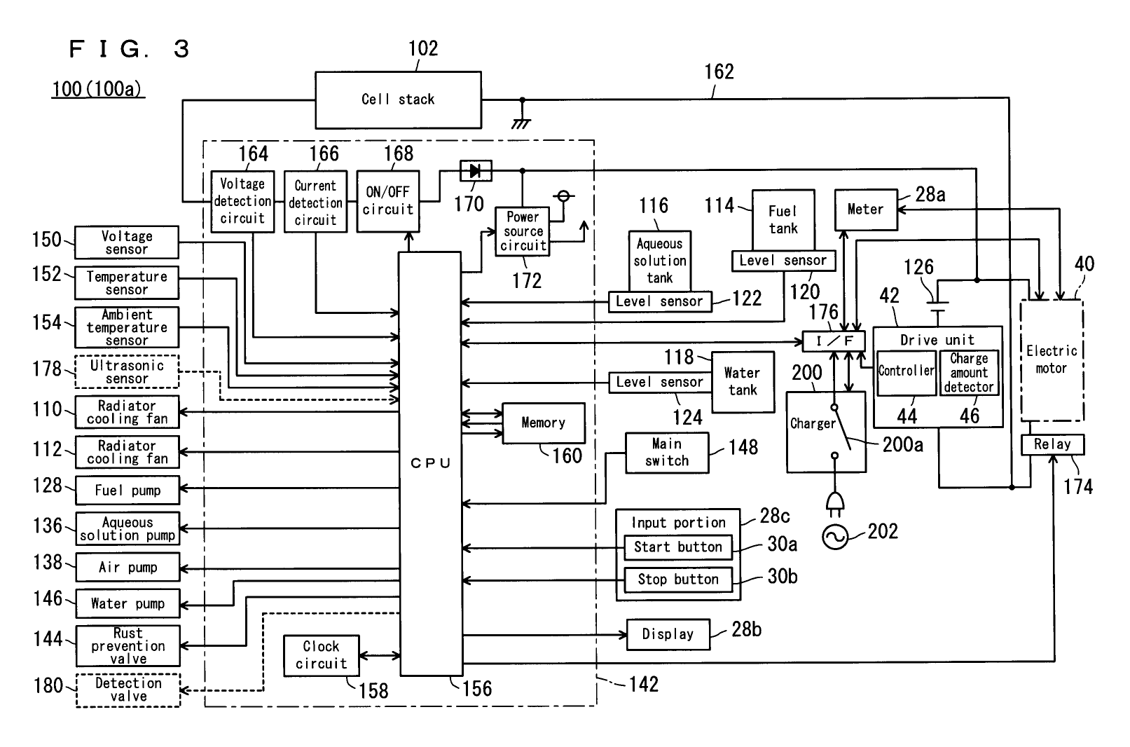

Referring also to FIG. 3, the display/operation board 28 is an integrated dashboard including a meter 28a for measuring and displaying various data concerning an electric motor 40 (to be described later), a display 28b provided by, e.g., a liquid crystal display for providing the driver with a variety of information concerning the ride, and an input portion 28c for inputting a variety of commands and data. The input portion 28c includes a start button 30a for issuing a power generation start command of a fuel cell stack (hereinafter simply called cell stack) 102 and a stop button 30b for issuing a power generation stop command of the cell stack 102.

As shown in FIG. 1, a pair of left and right front forks 32 extend from a bottom end of the steering shaft 22. Each of the front forks 32 includes a bottom end rotatably supporting a front wheel 34.

The rear frame 18 includes a lower end which pivotably supports a swing arm (rear arm) 36. The swing arm 36 has a rear end 36a incorporating the electric motor 40 of an axial gap type for example, which is connected with the rear wheel 38 to rotate the rear wheel 38. The swing arm 36 also incorporates a drive unit 42 which is electrically connected with the electric motor 40. The drive unit 42 includes a motor controller 44 for controlling the rotating drive of the electric motor 40, and a charge amount detector 46 for detecting the amount of charge in the secondary battery 126 (to be described later).

The motorbike 10 as described is equipped with a fuel cell system 100, with its constituent members being disposed along the vehicle frame 12. The fuel cell system 100 generates electric energy for driving the electric motor 40 and other system components.

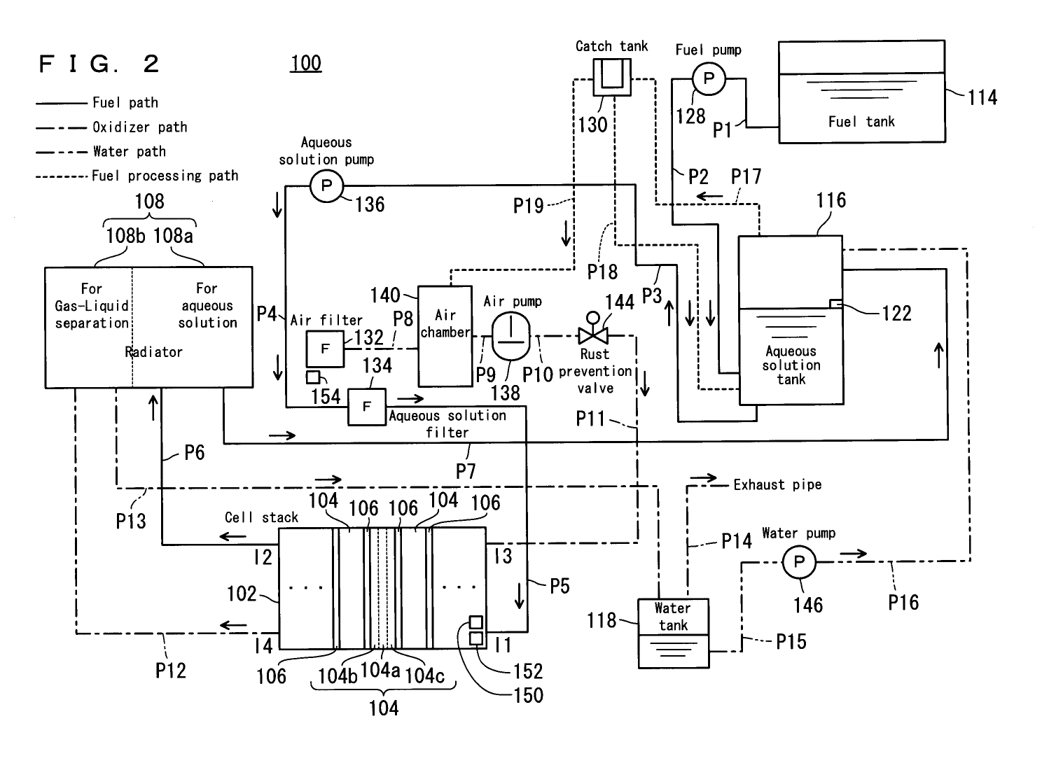

Hereinafter, the fuel cell system 100 will be described with reference to FIG. 1 and FIG. 2.

The fuel cell system 100 is preferably a direct methanol fuel cell system which uses methanol (an aqueous solution of methanol) directly without reformation for generation of electric energy (power generation).

The fuel cell system 100 includes the fuel cell stack 102. As shown in FIG. 1, the cell stack 102 is suspended from the flange 16c, and is disposed below the front frame 16.

As shown in FIG. 2, the cell stack 102 includes a plurality of fuel cells (individual fuel cells) 104 alternately layered (stacked) with separators 106. Each fuel cell 104 is capable of generating electric power through electrochemical reactions between hydrogen ions based on methanol and oxygen. Each fuel cell 104 in the cell stack 102 includes an electrolyte film 104a, such as a solid polymer film, for example, and an anode (fuel electrode) 104b and a cathode (air electrode) 104c opposed to each other with the electrolyte film 104a in between. The anode 104b and the cathode 104c each include a platinum catalyst layer provided on the side closer to the electrolyte film 104a.

As shown in FIG. 1, a radiator unit 108 is disposed below the front frame 16 and above the cell stack 102.

As shown in FIG. 2, the radiator unit 108 includes integrally therein, a radiator 108a for aqueous solution and a radiator 108b for gas-liquid separation. On a back side of the radiator unit 108, there is a fan 110 provided to cool the radiator 108a, and there is another fan 112 (see FIG. 3) provided to cool the radiator 108b. In FIG. 1, the radiators 108a and 108b are disposed side by side, with one on the left-hand side and the other on the right-hand side, and the figure shows the fan 110 for cooling the left-hand side radiator 108a.

A fuel tank 114, an aqueous solution tank 116, and a water tank 118 are disposed in this order from the top down between the pair of plate members in the rear frame 18.

The fuel tank 114 contains a methanol fuel (high concentration aqueous solution of methanol) having a high concentration level (containing methanol at approximately 50 wt %, for example) which is used as fuel for the electrochemical reaction in the cell stack 102. The aqueous solution tank 116 contains aqueous methanol solution, which is a solution of the methanol fuel from the fuel tank 114 diluted to a suitable concentration (containing methanol at approximately 3 wt %, for example) for the electrochemical reaction in the cell stack 102. The water tank 118 contains water which is produced in association with power generation in the cell stack 102.

The fuel tank 114 is provided with a level sensor 120 while the aqueous solution tank 116 is provided with a level sensor 122, and the water tank 118 is provided with a level sensor 124. The level sensors 120, 122, and 124 are float sensors each having an unillustrated float, for example, and detect the height of liquid (liquid level) in the respective tanks by the position of the moving float.

In front of the fuel tank 114 and above the front frame 16 is the secondary battery 126. The secondary battery 126 stores the electric power from the cell stack 102 and supplies the electric power to the electric components in response to commands from a controller 142 (to be described later). Above the secondary battery 126, a fuel pump 128 is disposed. Further, a catch tank 130 is disposed in front of the fuel tank 114, i.e., above and behind the secondary battery 126.

An air filter 132 is disposed in a space surrounded by the front frame 16, the cell stack 102, and the radiator unit 108 for removing impurities such as dust contained in the air. Behind and below the air filter 132, an aqueous solution filter 134 is disposed.

An aqueous solution pump 136 and an air pump 138 are housed in the storage space on the left side of the front frame 16. On the left side of the air pump 138 is an air chamber 140. The controller 142, a rust prevention valve 144, and a water pump 146 are disposed in the storage space on the right side of the front frame 16.

A main switch 148 is provided in the front frame 16 penetrating the storage space in the front frame 16 from right to left. Turning on the main switch 148 provides an operation start command to the controller 142 and turning off the main switch 148 provides an operation stop command to the controller 142.

As shown in FIG. 2, the fuel tank 114 and the fuel pump 128 are connected with each other by a pipe P1. The fuel pump 128 and the aqueous solution tank 116 are connected with each other by a pipe P2. The aqueous solution tank 116 and the aqueous solution pump 136 are connected with each other by a pipe P3. The aqueous solution pump 136 and the aqueous solution filter 134 are connected with each other by a pipe P4. The aqueous solution filter 134 and the cell stack 102 are connected with each other by a pipe P5. The pipe P5 is connected with an anode inlet I1 of the cell stack 102. By driving the aqueous solution pump 136, aqueous methanol solution is supplied to the cell stack 102. A voltage sensor 150 is provided near the anode inlet I1 of the cell stack 102 in order to detect concentration information, which reflects the concentration of aqueous methanol solution (the ratio of methanol in the aqueous methanol solution) supplied to the cell stack 102 using an electrochemical characteristic of the aqueous methanol solution. The voltage sensor 150 detects an open-circuit voltage of the fuel cell (fuel cells) 104, and the detected voltage value defines electrochemical concentration information. Based on the concentration information, the controller 142 detects the concentration of the aqueous methanol solution supplied to the cell stack 102. Near the anode inlet I1 of the cell stack 102, a temperature sensor 152 is provided in order to detect the temperature of aqueous methanol solution supplied to the cell stack 102.

The cell stack 102 and the aqueous solution radiator 108a are connected with each other by a pipe P6, and the radiator 108a and the aqueous solution tank 116 are connected with each other by a pipe P7. The pipe P6 is connected with an anode outlet I2 of the cell stack 102.

The pipes P1 through P7 serve primarily as a flow path for fuel.

The air filter 132 and the air chamber 140 are connected with each other by a pipe P8. The air chamber 140 and the air pump 138 are connected with each other by a pipe P9, the air pump 138 and the rust prevention valve 144 are connected with each other by a pipe P10 whereas the rust prevention valve 144 and the fuel cell stack 102 are connected with each other by a pipe P11. The pipe P11 is connected with a cathode inlet I3 of the cell stack 102. When the fuel cell system 100 generates power, the rust prevention valve 144 is opened. By driving the air pump 138 under this condition, air containing oxygen is introduced from outside. The rust prevention valve 144 is closed when the fuel cell system 100 is stopped to prevent backflow of water vapor into the air pump 138, and thereby prevent rusting of the air pump 138. An ambient temperature sensor 154 is provided near the air filter 132 to detect an ambient temperature.

The cell stack 102 and the gas-liquid separation radiator 108b are connected with each other by a pipe P12. The radiator 108b and the water tank 118 are connected with each other by a pipe P13. The water tank 118 is provided with a pipe (an exhaust pipe) P14. The pipe P14 is provided at an exhaust discharge outlet 118a (see FIG. 1) of the water tank 118, and discharges exhaust gas from the cell stack 102 to outside.

The pipes P8 through P14 serve primarily as a flow path for oxidizer.

The water tank 118 and the water pump 146 are connected with each other by a pipe P15 whereas the water pump 146 and the aqueous solution tank 116 are connected with each other by a pipe P16.

The pipes P15, P16 serve as a flow path for water.

The aqueous solution tank 116 and the catch tank 130 are connected with each other by pipes P17, P18. The catch tank 130 and the air chamber 140 are connected with each other by a pipe P19.

The pipes P17 through P19 constitute a flow path primarily for fuel processing.

Next, reference will be made to FIG. 3 to cover a preferred electrical configuration of the fuel cell system 100.

The controller 142 of the fuel cell system 100 preferably includes a CPU 156 for performing necessary calculations and controlling operations of the fuel cell system 100; a clock circuit 158 for providing the CPU 156 with a current time; a memory 160 provided by, e.g., an EEPROM for storing programs and data for controlling the operations of the fuel cell system 100 as well as calculation data, etc.; a voltage detection circuit 164 for detecting a voltage in an electric circuit 162 to connect the cell stack 102 with the electric motor 40 which drives the motorbike 10; an electric current detection circuit 166 for detecting an electric current which passes through the fuel cells 104, i.e., the cell stack 102; an ON/OFF circuit 168 for opening and closing the electric circuit 162; a diode 170 provided in the electric circuit 162; and a power source circuit 172 for providing the electric circuit 162 with a predetermined voltage.

The CPU 156 of the controller 142 as described above is supplied with detection signals from the level sensors 120, 122, and 124; detection signals from the voltage sensor 150, the temperature sensor 152, and the ambient temperature sensor 154; and detection signals from the charge amount detector 46. The CPU 156 detects the amount of liquid in each of the tanks based on relevant detection signals from the level sensors 120, 122, and 124 which reflect the respective liquid levels.

The CPU 156 is also supplied with input signals from the main switch 148 for turning ON or OFF the electric power, and input signals from the start button 30a and the stop button 30b in the input portion 28c.

Further, the CPU 156 is supplied with voltage values detected by the voltage detection circuit 164 and electric current values detected by the electric current detection circuit 166. The CPU 156 calculates an output from the cell stack 102 using the voltage values and electric current values supplied thereto. The CPU 156 monitors the output of the cell stack 102 and calculates the amount of power generated in a given period.

The CPU 156 controls system components such as the fuel pump 128, the aqueous solution pump 136, the air pump 138, the water pump 146, the fans 110, 112, and the rust prevention valve 144. For example, the CPU 156 controls the water pump 146 so that its output (the amount of water supplied per unit time) is constant. The CPU 156 also controls the display 28b which displays various kinds of information for the driver of the motorbike 10.

The cell stack 102 is connected with the secondary battery 126 and the drive unit 42. The secondary battery 126 and the drive unit 42 are connected with the electric motor 40 via an ON and OFF relay 174. The secondary battery 126 complements the output from the cell stack 102 by being charged with electric power from the cell stack 102 and discharging the electricity to supply power to the electric motor 40, the system components, etc.

The electric motor 40 is connected with the meter 28a for measuring various data concerning the electric motor 40. The data and status information of the electric motor 40 obtained by the meter 28a are supplied to the CPU 156 via the interface circuit 176.

In addition, a charger 200 is connectable with the interface circuit 176. The charger 200 is connectable with an external power source (commercial power source) 202. While the external power source 202 is connected with the interface circuit 176 via the charger 200, an external power source connection signal is sent to the CPU 156 via the interface circuit 176. The charger 200 has a switch 200a which can be turned ON/OFF by the CPU 156.

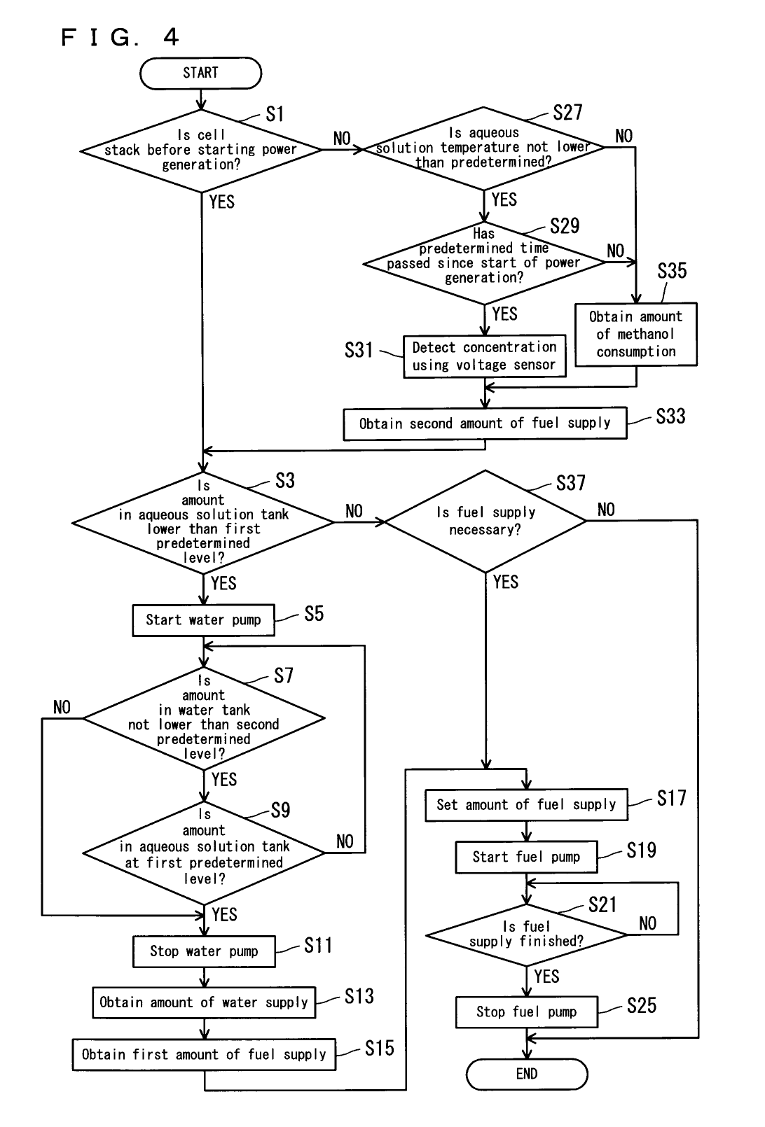

The memory 160 which defines the memory device stores programs for performing an operation shown in FIG. 4, conversion information for converting electrochemical concentration information (open-circuit voltage) obtained by the voltage sensor 150 into the concentration, conversion information for converting the amount of power generation in a given period obtained by the CPU 156 into the amount of methanol consumption, calculation data, etc.

In the present preferred embodiment, the aqueous solution tank 116 includes the aqueous solution container, the water tank 118 includes the water container, and the temperature sensor 152 includes the temperature detector. The CPU 156 also functions as the water supply amount obtaining device, the first fuel-supply amount obtaining device, the second fuel-supply amount obtaining device, the controller, and the determination device. The water supplying device includes the water pump 146, and the fuel supplying device includes the fuel pump 128. The concentration detector includes the voltage sensor 150 and the CPU 156. The consumption amount obtaining device includes the CPU 156, the clock circuit 158, the voltage detection circuit 164, and the electric current detection circuit 166. The time measuring device includes the CPU 156 and the clock circuit 158. The first liquid amount detector includes the level sensor 122 and the CPU 156. The second liquid amount detector includes the level sensor 124 and the CPU 156.

Next, description will cover a basic operation of the fuel cell system 100.

When the main switch 148 is turned on, the fuel cell system 100 starts the controller 142 and commences its operation. After the controller 142 is started, and when the amount of charge in the secondary battery 126 becomes not greater than a predetermined amount (for example, charge rate becomes not greater than about 40%) or when the start button 30a is pressed, system components such as the aqueous solution pump 136 and the air pump 138 are started using electricity from the secondary battery 126, and thus power generation in the cell stack 102 is started. The time at this point is obtained from the clock circuit 158 by the CPU 156, and recorded in the memory 160 as a time when the aqueous solution pump 136 and the air pump 138 were started, i.e., the time when power generation was started. On and after the power generation is started, an ON/OFF circuit 168 is turned on and the relay 174 is switched to bring the electric motor 40 into connection with the cell stack 102 and the secondary battery 126.

It should be noted here that in the fuel cell system 100, the cell stack 102 is connected with the secondary battery 126 on and after power generation is started. When the secondary battery 126 is fully charged, power generation in the cell stack 102 is stopped even if the stop button 30b is not pressed.

Referring now to FIG. 2, aqueous methanol solution in the aqueous solution tank 116 is sent via the pipes P3, P4 to the aqueous solution filter 134 as the aqueous solution pump 136 is driven. The aqueous solution filter 134 removes impurities and so on from the aqueous methanol solution, then the aqueous methanol solution is sent through the pipe P5 and the anode inlet I1, directly to the anode 104b in each of the fuel cells 104 which define the cell stack 102.

Meanwhile, gas (primarily containing carbon dioxide, vaporized methanol, and water vapor) in the aqueous solution tank 116 is supplied via the pipe P17 to the catch tank 130. The methanol vapor and water vapor are cooled in the catch tank 130, and the aqueous methanol solution obtained in the catch tank 130 is returned via the pipe P18 to the aqueous solution tank 116. On the other hand, gas (containing carbon dioxide, non-liquefied methanol and water vapor) in the catch tank 130 is supplied via the pipe P19 to the air chamber 140.

On the other hand, as the air pump 138 is driven, air is introduced through the air filter 132 and flows through the pipe P8 into the air chamber 140 where noise is silenced. The air which was introduced to the air chamber 140 and gas from the catch tank 130 flow via the pipe P9 to the air pump 138, and then through the pipe P10, the rust prevention valve 144, the pipe P11 and the cathode inlet I3, into the cathode 104c in each of the fuel cells 104 which define the cell stack 102.

At the anode 104b in each fuel cell 104, methanol and water in the supplied aqueous methanol solution chemically react with each other to produce carbon dioxide and hydrogen ions. The produced hydrogen ions flow to the cathode 104c via the electrolyte film 104a, and electrochemically react with oxygen in the air supplied to the cathode 104c, to produce water (water vapor) and electric energy. Thus, power generation is performed in the cell stack 102. The electricity from the cell stack 102 is used to charge the secondary battery 126, to drive the motorbike 10 and so on. The temperature of the cell stack 102 is increased by the heat associated with the electrochemical reactions. The output of the cell stack 102 increases as the temperature rises, and the cell stack 102 becomes able to perform normal constant power generation at approximately 50° C. The temperature of the cell stack 102 can be checked by the temperature of aqueous methanol solution detected by the temperature sensor 152.

The temperatures of carbon dioxide produced at the anode 104b in each fuel cell 104 and of aqueous methanol solution which includes unused methanol are increased by the heat associated with the electrochemical reaction. The carbon dioxide and the aqueous methanol solution flow from the anode outlet I2 of the cell stack 102 through the pipe P6 into the radiator 108a where they are cooled. The cooling of the carbon dioxide and the methanol is facilitated by driving the fan 110. The carbon dioxide and the aqueous methanol solution which have been cooled then flow through the pipe P7, and return to the aqueous solution tank 116. In other words, a circulating supply of aqueous methanol solution which is held in the aqueous solution tank 116 is provided to the cell stack 102.

During power generation, bubbles are produced in the aqueous methanol solution in the aqueous solution tank 116 due to the return flow of carbon dioxide and aqueous methanol solution from the cell stack 102, the supply flow of methanol fuel from the fuel tank 114, and the supply flow of water from the water tank 118. The float of the level sensor 122 moves up with the bubbles, and therefore the liquid level detected by the level sensor 122 during power generation is higher than the actual liquid level of the aqueous methanol solution. In other words, the amount of the liquid in the aqueous solution tank 116 is recognized as being greater than the actual amount of the liquid during power generation.

Meanwhile, most of the water vapor produced on the cathode 104c in each fuel cell 104 is liquefied and discharged in the form of water from the cathode outlet I4 of the cell stack 102, with saturated water vapor being discharged in the form of gas. The water vapor which was discharged from the cathode outlet I4 is supplied via the pipe P12 to the radiator 108b, where it is cooled and its portion is liquefied as its temperature decreases to or below the dew point. The liquefying operation of the water vapor by the radiator 108b is facilitated by operation of the fan 112. Discharge from the cathode outlet I4, which contains water (liquid water and water vapor), carbon dioxide and unused air, is supplied via the pipe P12, the radiator 108b and the pipe P13, to the water tank 118 where water is collected, and thereafter, discharged to the outside via the exhaust discharge outlet 118a of the water tank 118 and the pipe P14.

At the cathode 104c in each fuel cell 104, the vaporized methanol from the catch tank 130 and methanol which has moved to the cathode 104c due to crossover react with oxygen in the platinum catalyst layer, thereby being decomposed to harmless water and carbon dioxide. The water and carbon dioxide which are produced from the methanol are discharged from the cathode outlet I4 and supplied to the water tank 118 via the radiator 108b. Further, water which has moved due to water crossover to the cathode 104c in each fuel cell 104 is discharged from the cathode outlet I4 and supplied to the water tank 118 via the radiator 108b.

The water in the water tank 118 is recycled appropriately by a pumping operation of the water pump 146 through the pipes P15, P16 to the aqueous solution tank 116. Also, methanol fuel in the fuel tank 114 is supplied appropriately by a pumping operation of the fuel pump 128, through the pipes P1, P2 to the aqueous solution tank 116.

In the fuel cell system 100, the fuel pump 128 and the water pump 146 are controlled so as to bring the amount of liquid in the aqueous solution tank 116 to a first predetermined amount (about 500 cc, for example) while aqueous methanol solution in the aqueous solution tank 116 is adjusted to a desired concentration. In other words, a concentration/liquid-amount adjusting process is performed.

Next, reference will be made to FIG. 4 to describe the concentration/liquid-amount adjusting process in the fuel cell system 100. In the following description, the first concentration/liquid-amount adjusting process is performed right after the start of operation (right after the main switch 148 is turned on), and thereafter, the concentration/liquid-amount adjusting process is performed at a regular interval (about every 10 seconds, for example).

First, the CPU 156 determines whether or not power generation in the cell stack 102 has been started (Step S1). If power generation in the cell stack 102 has not yet started, the CPU 156 then determines whether or not the level of aqueous methanol solution in the aqueous solution tank 116 is lower than a first predetermined amount (e.g., about 500 cc) based on a detection signal from the level sensor 122 (Step S3).

As has been described, when the power operation is underway, the adjustment brings the amount of liquid in the aqueous solution tank 116 to the first predetermined amount based on the level of the liquid which contains bubbles. Since the bubbles disappear after power generation is stopped, the float location in the level sensor 122 after power generation is stopped is lower than the location which represented the first predetermined amount. In other words, a liquid level after power generation is stopped is lower than the liquid level which represents the first predetermined amount. Therefore, normally, in the first concentration/liquid-amount adjusting process, Step S3 determines that the amount of liquid in the aqueous solution tank 116 is lower than the first predetermined amount.

If Step S3 determines that the amount of liquid in the aqueous solution tank 116 is lower than the first predetermined amount, the CPU 156 starts the water pump 146 (Step S5). The CPU 156 obtains the time at this point from the clock circuit 158, and records that time in the memory 160 as a driving start time of the water pump 146.

Next, the CPU 156 determines whether or not the amount of liquid in the water tank 118 is not lower than the second predetermined amount (about 100 cc, for example) based on a detection signal from the level sensor 124 (Step S7). If the amount of liquid in the water tank 118 is not smaller than the second predetermined amount, the CPU 156 continues the operation of the water pump 146 until the amount of liquid in the aqueous solution tank 116 reaches the first predetermined amount (as long as Step S9 determines NO).

Then, when Step S9 determines that the amount of liquid in the aqueous solution tank 116 has reached the first predetermined amount, the CPU 156 stops the water pump 146 (Step S11). The CPU 156 obtains the time at this point from the clock circuit 158, and records the time in the memory 160 as a driving stop time of the water pump 146. The process also goes to Step 11 if Step S7 determines that the amount of liquid in the water tank 118 has become lower than the second predetermined amount.

Next, the CPU 156 calculates a difference between the driving start time and the driving stop time of the water pump 146 recorded in the memory 160. In other words, the time for which the water pump 146 was driven is calculated. Then, by using this drive time and the output of the water pump 146, the CPU 156 obtains the amount of water supplied to the aqueous solution tank 116 (Step S13). In the present preferred embodiment, the data regarding the supplied amount of water is the amount of water supplied itself.

As described earlier, the water pump 146 is controlled so that its output (the amount of water supplied per unit time) is constant. Therefore in Step S13, the amount of water supplied from the time when the water pump 146 was started to the time it was stopped is obtained by calculating a product between the drive time of the water pump 146 and the amount of water supplied (the amount of output) by the water pump 146 per unit time.

Next, the CPU 156 calculates the amount of methanol fuel necessary for making aqueous methanol solution of a desired concentration from the supplied amount of water, and records this amount in the memory 160 as a first supplied amount of fuel. In other words, the first supplied amount of fuel is obtained (Step S15). In the present preferred embodiment, the data regarding the supplied amount of fuel is the first supplied amount of fuel itself.

Next, the CPU 156 sets the amount of methanol fuel to be supplied to the aqueous solution tank 116 to the value of the first supplied amount of fuel which is stored in the memory 160 (Step S17), and then starts the fuel pump 128 (Step S19). Thereafter, when Step S21 determines that the amount of methanol fuel set in Step S17 has been supplied, the fuel pump 128 is stopped (Step S25), and the concentration/liquid-amount adjusting process comes to an end.

On the other hand, if Step S1 determines that power generation in the cell stack 102 has already been started, the CPU 156 determines whether or not the temperature of the aqueous methanol solution is not lower than a predetermined temperature (about 45° C., for example) (Step S27), based on a detection result by the temperature sensor 152.

In the voltage sensor 150, an open-circuit voltage difference between two different concentrations is larger when the temperature of the aqueous fuel solution is higher, because chemical changes in aqueous methanol solution are more active when the temperature is higher. For this reason, when the temperature of the aqueous methanol solution is relatively low, the concentration of aqueous methanol solution detected by using the voltage sensor 150 is not very reliable. Based on this fact, in the fuel cell system 100, Step S27 determines whether or not the concentration of aqueous methanol solution detected by using the voltage sensor 150 is reliable, based on the temperature of the aqueous methanol solution. The predetermined temperature referred in Step S27 (about 45° C. in the present preferred embodiment) is set to a temperature not lower than the temperature at which chemical changes in the aqueous methanol solution becomes active. In other words, the setting is made so that the concentration in the aqueous methanol solution can be detected accurately by using the voltage sensor 150.

If Step S27 determines that the temperature of the aqueous methanol solution is not lower than the predetermined temperature, the CPU 156 obtains the current time from the clock circuit 158, and calculates a difference between the current time which was obtained and the time at which the aqueous solution pump 136 and the air pump 138 were started, i.e., the time recorded in the memory 160. In other words, the elapsed time from the start of power generation in the cell stack 102 is obtained. Then, the CPU 156 determines whether or not a predetermined amount of time (about 10 minutes, for example) has passed since the start of power generation (Step S29).

For a while after power generation is started, aqueous methanol solution which has moved to the cathode 104c due to crossover phenomenon attaches to the platinum catalyst layer, and prevents oxygen from making contact with the platinum catalyst layer, making the open-circuit voltage of the fuel cell 104 unstable. For this reason, the concentration of aqueous methanol solution detected by using the voltage sensor 150 is not very reliable until the aqueous methanol solution surrounding the cathode 104c has been almost completely blown off by air which is supplied by the air pump 138. Therefore, in the fuel cell system 100, Step S29 determines whether or not the concentration of aqueous methanol solution detected by using the voltage sensor 150 is reliable based on the elapsed time from the start of the power generation. The predetermined time used in Step S29 (about 10 minutes in the present preferred embodiment) is a time not shorter than a normally anticipated amount of time necessary for the air from the air pump 138 to almost completely remove the aqueous methanol solution which attached to the platinum catalyst layer of the cathode 104c.

It should be noted here that open-circuit voltage cannot be detected unless power generation is underway in the cell stack 102, so, it is obviously not possible to detect the concentration of aqueous methanol solution by using the voltage sensor 150 before starting the power generation in the cell stack 102.

If Step S29 determines that the predetermined time has passed since the power generation was started, the CPU 156 detects the concentration of aqueous methanol solution using the voltage sensor 150 (Step S31). Then, based on the concentration detected by using the voltage sensor 150 and the amount of liquid detected by using the level sensor 122, the CPU 156 calculates the amount of methanol fuel necessary for bringing the aqueous methanol solution in the aqueous solution tank 116 to a desired concentration. Thereafter, the calculated amount of aqueous methanol solution is recorded in the memory 160 as a second supplied amount of fuel, and then the process goes to Step S3. In other words, the process obtains the second supplied amount of fuel based on the state of aqueous methanol solution before water is supplied (Step S33), and then goes to Step S3. In the present preferred embodiment, the data regarding the supplied amount of fuel is the second supplied amount of fuel itself.

In the case where the process goes from Step S33 to Step S3, and if Step S3 determines that the amount of liquid in the aqueous solution tank 116 is lower than the first predetermined amount, then Step S17 sets the amount of methanol fuel supply to a sum of the first supplied amount of fuel and the second supplied amount of fuel. In other words, the amount of methanol fuel supply is set to a sum of the first supplied amount of fuel which reflects a concentration change due to the water supply and the second supplied amount of fuel which reflects a concentration change associated with methanol consumption in the cell stack 102 and a concentration change due to crossover and evaporation.

Also, if Step S27 determines that the temperature of the aqueous methanol solution is lower than the predetermined temperature, or if Step S29 determines that the predetermined amount of time has not passed since the start of power generation, the CPU 156 obtains the amount of methanol consumption associated with the power generation in the cell stack 102 (Step S35).

In Step S35, the CPU 156 calculates an amount of power generation in the cell stack 102 for a period of time from Step S35 in the previous concentration/liquid-amount adjusting process to Step S35 in the current concentration/liquid-amount adjusting process (an example of the given period), and then, obtains the amount of methanol consumption which represents the amount of power generation, using the conversion information stored in the memory 160. It should be noted here that if Step S35 was not performed in the previous concentration/liquid-amount adjusting process, the amount of methanol consumption can be obtained based on an amount of power generation from the start of power generation. Thereafter, the process goes to Step S33, where the second supplied amount of fuel which represents a concentration change associated with the methanol consumption is obtained.

If Step S3 determines that the amount of liquid in the aqueous solution tank 116 is not lower than the first predetermined amount, the CPU 156 determines whether or not it is necessary to supply methanol fuel to the aqueous solution tank 116 (Step S37). In Step S37, the determination whether or not it is necessary to supply methanol fuel to the aqueous solution tank 116 is made based on whether or not the second supplied amount of fuel is recorded in the memory 160.

If Step S37 determines that the second supplied amount of fuel is recorded in the memory 160, Step S17 sets the amount of methanol fuel supply to the value of the second supplied amount of fuel, and thus methanol fuel by the amount of the second supplied amount of fuel is supplied to the aqueous solution tank 116. On the other hand, if Step S37 determines that the second supplied amount of fuel is not recorded in the memory 160, the concentration/liquid-amount adjusting process comes to an end.

It should be noted here that description was made for a case where Step S13 obtains the supplied amount of water using the drive time and output of the water pump 146. However, the supplied amount of water may be obtained by any method.

For example, the supplied amount of water may be obtained based on a result of detection of the amount of liquid in the aqueous solution tank 116. In this case, the level sensor 122 is used to detect the amount of aqueous methanol solution in the aqueous solution tank 116 before starting the water pump 146 and after stopping the water pump 146, and a difference between the two is obtained as the supplied amount of water to the aqueous solution tank 116. By using the amount of the increase in the amount of liquid held in the aqueous solution tank 116 associated with the supply of water as the supplied amount of water as described, it becomes possible to obtain the supplied amount of water more accurately.

Also, the supplied amount of water may be obtained based on a result of detection of the amount of liquid (amount of water) in the water tank 118. In this case, the level sensor 124 is used to detect the amount of liquid in the water tank 118 before starting the water pump 146 and after stopping the water pump 146, and a difference between the two is obtained as the amount of water supplied to the aqueous solution tank 116. By using the amount of the decrease in the amount of liquid held in the water tank 118 associated with the supply of water as the supplied amount of water as described, it becomes possible to obtain the supplied amount of water more accurately.

Further, the supplied amount of water may be obtained before the water supply, through a calculation of a difference between the amount of liquid in the aqueous solution tank 116 detected by using the level sensor 122 before the water supply and the first predetermined amount (about 500 cc in the present preferred embodiment). In this case, the amount of methanol fuel supply may be set before the water supply based on the calculated supplied amount of water, and supply of methanol fuel to the aqueous solution tank 116 may be started by the time the water supply is finished.

The predetermined temperature in Step S27 may be set to any value as long as the value is within a range which allows accurate detection of the concentration of aqueous methanol solution by using the voltage sensor 150. Likewise, the predetermined time in Step S29 may be set to any value as long as the value is within a range which allows removal of aqueous methanol solution attached to the platinum catalyst layer of the cathode 104c by the supply of air.

The amount of methanol consumption in the cell stack 102 may be obtained also in the case where the process goes from Step S31 to Step S33. In this case, the amount of methanol fuel supply according to the methanol consumption is obtained first, and then methanol fuel is supplied by that amount to the aqueous solution tank 116. Thereafter, concentration of aqueous methanol solution is detected by using the voltage sensor 150, and if a result of the detection is not a desired concentration, the desired concentration is achieved by supplying methanol fuel or water to the aqueous solution tank 116. In this case therefore, the process goes to Step S3 without obtaining the second supplied amount of fuel.

In the operation in FIG. 4, the target concentration (desired concentration) of aqueous methanol solution may be a fixed concentration or may be varied depending on the state of operation of the fuel cell system. For example, if the temperature of aqueous methanol solution, i.e., of the cell stack 102 is low, concentration of the aqueous methanol solution may be increased beyond the value for normal operation (about 3 wt %) in order to raise the temperature of the cell stack 102 quickly. Specifically, when the temperature of the cell stack 102 is low, the concentration of the aqueous methanol solution may be adjusted to about 5 wt %, for example.

The process from Step S19 through Step S25 may be performed before going from Step S33 to Step S3. In other words, the fuel pump 128 may be started right after the second supplied amount of fuel is obtained, and the methanol fuel supply may be made by the second supplied amount of fuel.

According to the fuel cell system 100 as described, it is possible to supply methanol fuel to the aqueous solution tank 116 according to the supplied amount of water. With this arrangement, it becomes possible to reduce the concentration change in the aqueous methanol solution even if water is supplied to the aqueous solution tank 116 during a period when it is impossible to appropriately adjust the concentration of the aqueous methanol solution because of low reliability of the concentration detected by using the voltage sensor 150.

By obtaining the first supplied amount of fuel according to the supplied amount of water, it becomes possible to supply an appropriate amount of methanol fuel to the aqueous solution tank 116.

By obtaining the second supplied amount of fuel according to the state of aqueous methanol solution before water is supplied, and by supplying methanol fuel to the aqueous solution tank 116 based on the first supplied amount of fuel and the second supplied amount of fuel, it becomes possible to bring the aqueous methanol solution which is to be supplied to the cell stack 102 close to a desired concentration.

By using a sum of the first supplied amount of fuel and the second supplied amount of fuel which is obtained based on a result of the concentration detection as the amount of methanol fuel to be supplied, it becomes possible to reduce concentration changes due to water supply, concentration change associated with methanol consumption, and concentration change associated with crossover and evaporation. Therefore, it becomes possible to more reliably bring the aqueous methanol solution which is to be supplied to the cell stack 102 close to a desired concentration.

By obtaining the second supplied amount of fuel based on the amount of methanol consumption, it becomes possible to reduce at least concentration changes due to methanol consumption even when a result of the concentration detection cannot be used to obtain the second supplied amount of fuel. Therefore, it becomes possible to reduce the concentration change in the aqueous methanol solution in the aqueous solution tank 116 more reliably.

Based on a result of detection by the temperature sensor 152 and the elapsed time from the start of power generation in the cell stack 102, it is possible to easily determine whether or not the concentration detected by using the voltage sensor 150 is reliable.

By supplying water which is produced in power generation in the cell stack 102 to the aqueous solution tank 116, it becomes possible to replenish water within the system without supplying water externally.

By holding water which comes from the cell stack 102 in the water tank 118, it becomes possible to supply water more efficiently to the aqueous solution tank 116 than in an arrangement where water is supplied directly from the cell stack 102 to the aqueous solution tank 116 together with exhaust gas. Also, by holding water in the water tank 118, the water pump 146 now supplies water almost purely. Thus, it is possible to obtain the supplied amount of water easily and accurately in a case where the supplied amount of water to the aqueous solution tank 116 is obtained by using the drive time and output of the water pump 146.

Since it is possible to supply methanol fuel to the aqueous solution tank 116 according to the supplied amount of water, it is possible to reduce the concentration change in the aqueous methanol solution reliably, even if the level sensor 122 is provided by a float sensor and if a large amount of water is supplied to the aqueous solution tank 116 in order to maintain the liquid level at the first predetermined amount.

By supplying water within a limit where the amount of liquid in the aqueous solution tank 116 does not exceed the first predetermined amount, and by supplying methanol fuel according to the supplied amount of water, it becomes possible to control the amount of aqueous solution in the aqueous solution tank 116 at an appropriate level, as well as to perform concentration adjustment accurately.

Since it is possible to stop water supply when the amount of liquid in the water tank 118 becomes lower than the second predetermined amount, it is possible to prevent the water pump 146 from running dry without water, as well as to obtain the supplied amount of water accurately.

Preferably, the motorbike 10 should be able to run stably. Since the fuel cell system 100 is capable of reducing concentration changes in the aqueous methanol solution, it is capable of stabilizing the output from the fuel cell 102, and driving the system components stably. Therefore, the fuel cell system 100 can be used suitably for transportation equipment such as the motorbike 10.

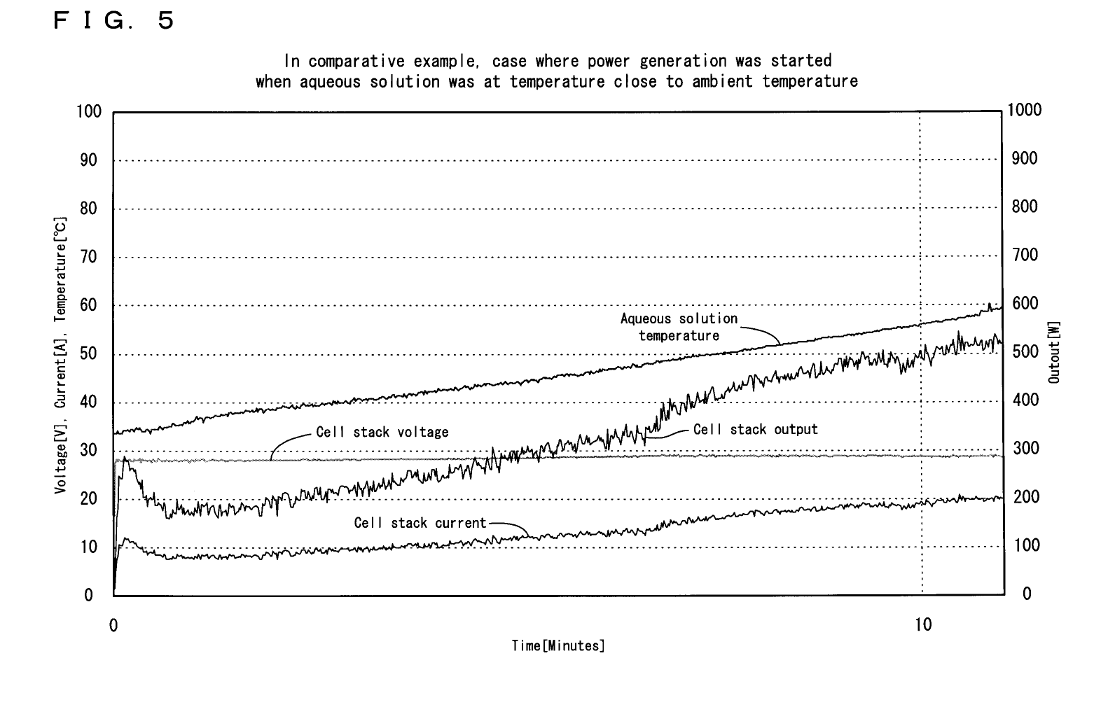

Next, reference will be made to FIG. 5 through FIG. 8 to compare the fuel cell system 100 with another fuel cell system (hereinafter called a comparative example) in terms of timecourse change in their cell stack output, voltage and current, as well as the temperature of the aqueous methanol solution (cell stack).

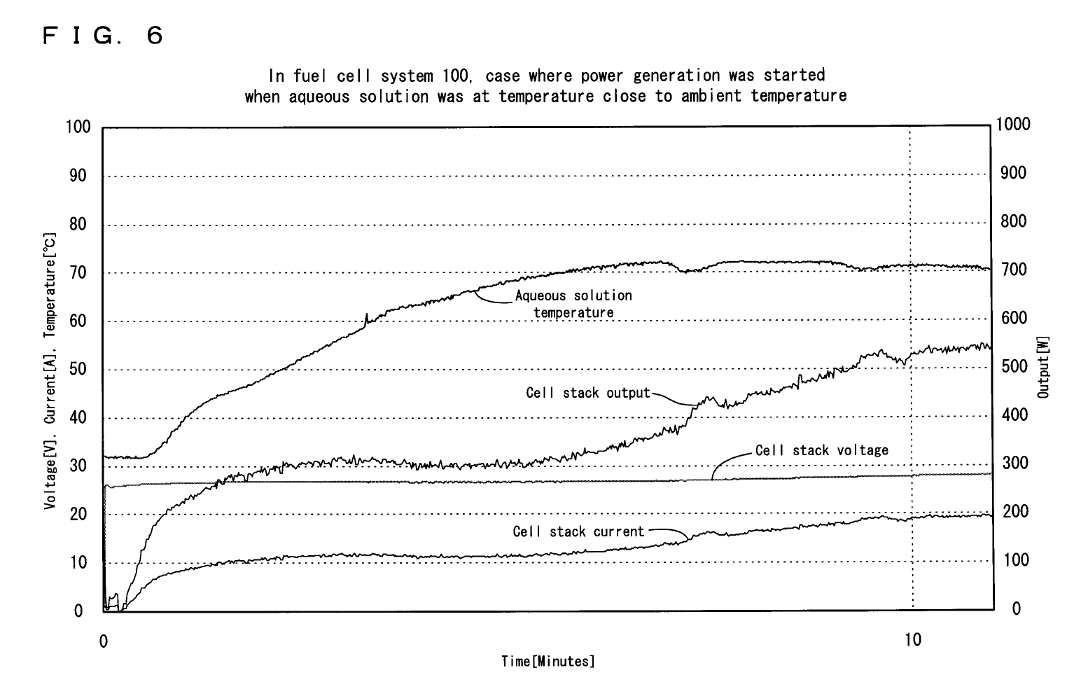

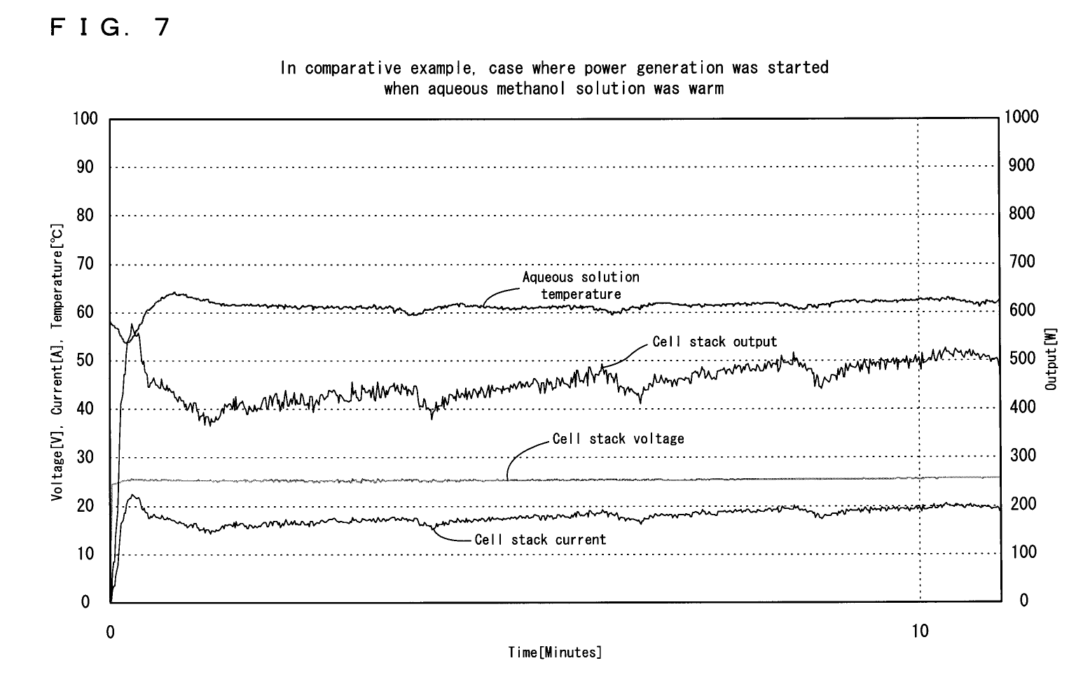

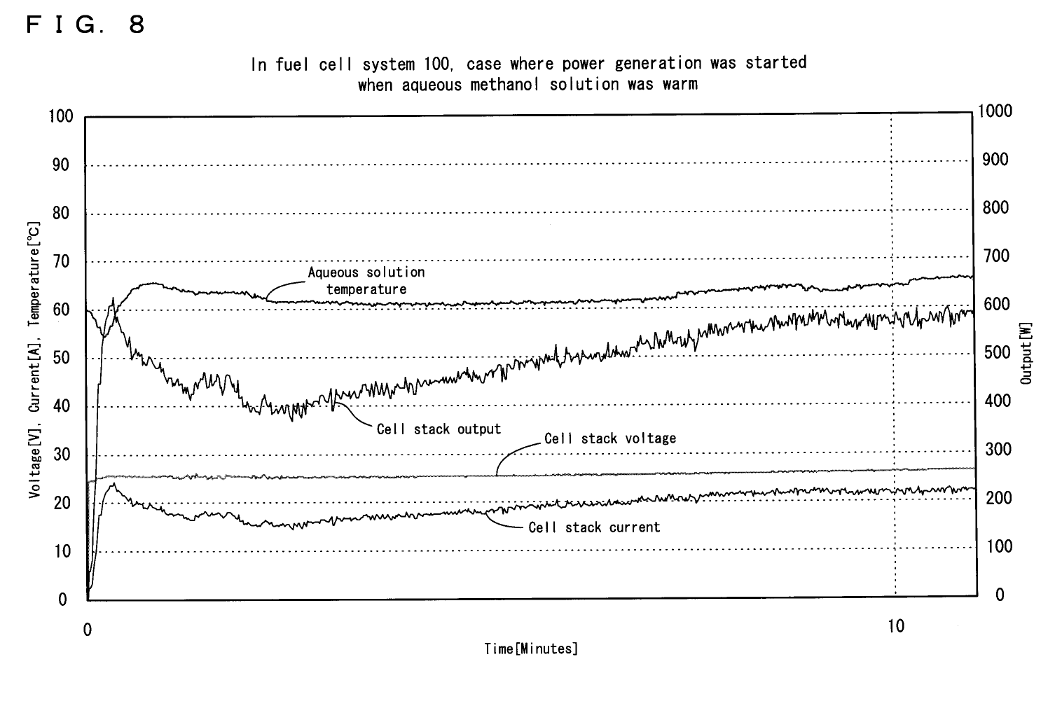

FIG. 5 and FIG. 6 show timecourse changes when power generation was started with the aqueous methanol solution at a temperature close to an ambient temperature. FIG. 5 shows changes in the comparative example whereas FIG. 6 shows changes in the fuel cell system 100. FIG. 7 and FIG. 8 show timecourse changes in a case where, for example, the secondary battery was fully charged and so power generation in the cell stack was stopped temporarily, and then power generation was started (resumed). In other words, these figures show timecourse changes in a case where power generation was started when the temperature of aqueous methanol solution was higher than a normally anticipated ambient temperature. FIG. 7 shows timecourse changes in the comparative example whereas FIG. 8 shows timecourse changes in the fuel cell system 100.

In both of the fuel cell system 100 and the comparative example, and in both cases where aqueous methanol solution was approximately at an ambient temperature and where aqueous methanol solution was warm, the first water supply was performed right after system operation was started. After power generation was started, water supply was performed every about 10 seconds.

In the comparative example, only methanol fuel supply based on methanol consumption by the cell stack was performed until concentration detection by using the voltage sensor became possible (until about 10 minutes elapsed from the start of power generation). In other words, in the comparative example, an operation such as methanol fuel supply according to the supplied amount of water was not performed unlike in the fuel cell system 100.

Now, first, comparison between the fuel cell system 100 and the comparative example will be made for the case where power generation was started when the temperature of the aqueous methanol solution was approximately at an ambient temperature.

As shown in FIG. 5, in the comparative example, concentration of the aqueous methanol solution was decreased by the water supply. Therefore, the rate of temperature increase in the aqueous methanol solution was also decreased, and the system was not able to maintain its output at a level not lower than about 500 W until about ten minutes have passed since the power generation was started.

On the other hand, as shown in FIG. 6, in the fuel cell system 100, it was possible to reduce the concentration drop in the aqueous methanol solution by supplying the amount of methanol fuel according to the supplied amount of water, and as a result, the electric current, i.e., the output did not decrease in association with the water supply. Also, since the fuel cell system 100 was able to reduce the concentration drop in the aqueous methanol solution, it was possible to raise the temperature of the aqueous methanol solution quickly, and to increase the output quickly. Specifically, the system was able to maintain its output at a level not lower than about 500 W before about ten minutes have passed since the power generation was started.

Next, comparison between the fuel cell system 100 and the comparative example will be made for the case where power generation was started when the temperature of the aqueous methanol solution was high.

As shown in FIG. 7, in the comparative example, the current, i.e., the output, dropped from time to time, and the system was not able to maintain its output at a level not lower than about 500 W until about ten minutes have passed since the power generation was started.

On the other hand, as shown in FIG. 8, the fuel cell system 100 was able to increase the current, i.e., the output, quickly by supplying methanol fuel according to the amount of methanol consumption and the supplied amount of water. As a result, the system was able to maintain its output at a level not lower than about 500 W in approximately seven minutes after the power generation was started.

As exemplified, the fuel cell system 100 was able to increase its output quickly and maintain a high output by reducing the concentration change in the aqueous methanol solution. In other words, the system was able to stabilize the output quickly.

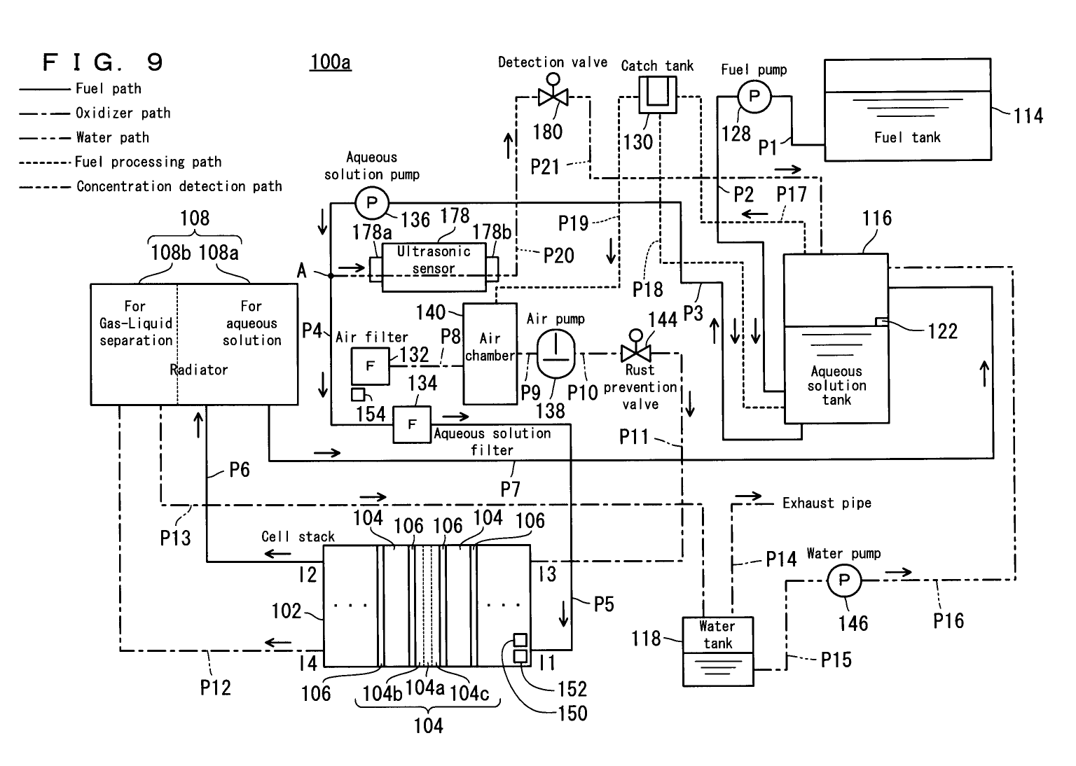

Next, reference will be made to FIG. 3 and FIG. 9 to describe a fuel cell system 100a as another preferred embodiment of the present invention.

As shown in FIG. 9, the fuel cell system 100a includes a concentration detection flow path provided by pipes P20, P21, an ultrasonic sensor 178 attached to the pipe P20, and a detection valve 180 which connects the two pipes P20 and P21. Other aspects are the same as the fuel cell system 100 described earlier, so description will not be repeated.

The pipe P20 is connected to a branching section A of the pipe P4 so that a portion of aqueous methanol solution which flows through the pipe P4 will flow in. The ultrasonic sensor 178 is arranged to detect the concentration of the aqueous methanol solution, based on the principle that a travel time (propagation speed) of ultrasonic waves changes depending on the concentration. The ultrasonic sensor 178 includes a transmitter unit 178a and a receiver unit 178b. An ultrasonic wave transmitted from the transmitter unit 178a is received by the receiver unit 178b to detect an ultrasonic wave travel time in the pipe P20, and a voltage value which represents the travel time is taken as physical concentration information.

In the ultrasonic sensor 178 as described, the voltage difference between two different concentrations becomes larger as the temperature of the aqueous methanol solution becomes lower, because the difference in ultrasonic wave propagation speed in water and in methanol becomes larger as the temperature becomes lower. Therefore, when the temperature of aqueous methanol solution is relatively low, it is possible to detect the concentration of aqueous methanol solution accurately by using the ultrasonic sensor 178.

The CPU 156 obtains a concentration of aqueous methanol solution in the pipe P20, using the physical concentration information obtained by the ultrasonic sensor 178 and conversion information for converting the physical concentration information (a voltage which represents the propagation time) into the concentration. In other words, the fuel cell system 100a is the fuel cell system 100 provided with a concentration detector which includes the CPU 156 and the ultrasonic sensor 178. The conversion information for converting physical concentration information obtained by the ultrasonic sensor 178 into the concentration is stored in the memory 160 in advance.

The pipe P20 is connected with the detection valve 180. The detection valve 180 and the aqueous solution tank 116 communicate with each other via the pipe P21. At a time of concentration detection, the detection valve 180 is closed to stop the flow of aqueous methanol solution in the pipe P20. After the concentration is detected, the detection valve 180 is opened to release the aqueous methanol solution, whose concentration has been detected, back to the aqueous solution tank 116.

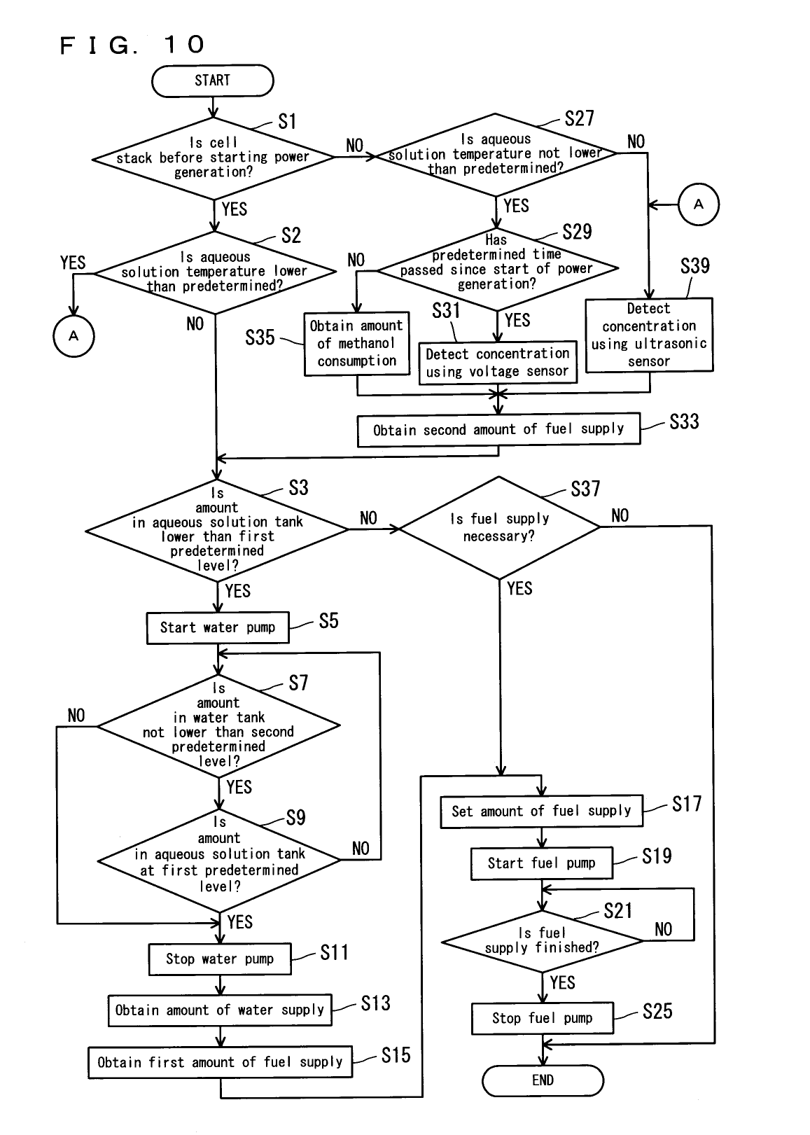

Next, reference will be made to FIG. 10 to describe a concentration/liquid-amount adjusting process in the fuel cell system 100a. The concentration/liquid-amount adjusting process in FIG. 10 is the concentration/liquid-amount adjusting process shown in FIG. 4 which further includes Steps S2 and S39. In the concentration/liquid-amount adjusting process in FIG. 10, the process goes to Step S2 if Step S1 determines YES. If Step S27 determines NO, the process goes to Step S39. The other processes are the same as the concentration/liquid-amount adjusting process in FIG. 4, so description will not be repeated.

First, if Step S1 determines that the cell stack 102 has not started power generation, the CPU 156 determines whether or not the temperature of aqueous methanol solution is lower than a predetermined temperature (for example, about 45° C.), based on a result of detection by the temperature sensor 152 (Step S2). If Step S2 determines that the temperature of the aqueous methanol solution is lower than the predetermined temperature, the CPU 156 detects the concentration of the aqueous methanol solution by using the ultrasonic sensor 178 (Step S39), and the process goes to Step S33. In this case, Step S33 calculates an amount of methanol fuel supply necessary for bringing the aqueous methanol solution in the aqueous solution tank 116 to a desired concentration based on the concentration detected by using the ultrasonic sensor 178 and the amount of liquid detected by using the level sensor 122. Then, the calculated amount of supply is obtained as the second amount of fuel supply. If Step S2 determines that the temperature of the aqueous methanol solution is not lower than the predetermined temperature (about 45° C.), then the process goes to Step S3.

On the other hand, if Step S1 determines that the cell stack 102 has already started power generation, Step S27 determines whether or not the aqueous methanol solution is not lower than the predetermined temperature (about 45° C.). If Step S27 determines that the temperature of the aqueous methanol solution is lower than the predetermined temperature, the process goes to Step S39. Then, the concentration of the aqueous methanol solution is detected by using the ultrasonic sensor 178, and Step S33 obtains the second supplied amount of fuel based on the concentration detected by using the ultrasonic sensor 178.

According to the fuel cell system 100a as described above, it is possible to detect the concentration of aqueous methanol solution even before starting power generation in the cell stack 102 as long as the temperature of the aqueous methanol solution is lower than a predetermined temperature, whereby it is possible to obtain the second supplied amount of fuel for reducing a concentration change associated with crossover and evaporation. Also, it is possible to detect a concentration of the aqueous methanol solution and to obtain the second supplied amount of fuel even if power generation was started when the aqueous methanol solution was at a temperature close to ambient temperature and the temperature of the aqueous methanol solution after the power generation has been started is lower than a predetermined temperature. In other words, it is possible to obtain the second supplied amount of fuel for reducing concentration change associated with methanol consumption and concentration change associated with crossover and evaporation even if the temperature of the aqueous methanol solution after the power generation has been started is lower than a predetermined temperature. Therefore, it is possible to bring the concentration of aqueous methanol solution which is to be supplied to the cell stack 102 more closely to a desired concentration.

It should be noted here that, in each of the preferred embodiments given above, description was made for a case where water which is held in the water tank 118 is supplied to the aqueous solution tank 116. However, water may be supplied directly from the cell stack 102 to the aqueous solution tank 116 together with exhaust gas. In this case, the amount of water supplied to the aqueous solution tank 116 may be obtained based on the output and temperature of the cell stack 102 and cooling capacity of the gas-liquid separation radiator 108b. Also, in this case, the amount of water supplied to the aqueous solution tank 116 may be obtained from the diameter of the flow path from the cell stack 102 to the aqueous solution tank 116, and the velocity of water and exhaust gas flow in the flow path.

In each of the preferred embodiments given above, description was made for a case where water which was produced by electrochemical reactions in the cell stack 102 is supplied to the aqueous solution tank 116. However, the water may be supplied from the outside to the aqueous solution tank 116.

Further, in each of the preferred embodiments given above, data regarding the supplied amount of water is the amount of the water supply itself, and data regarding the supplied amount of fuel is the first supplied amount of fuel and the second supplied amount of fuel themselves. However, the present invention is not limited to these preferred embodiments. The data regarding the supplied amount of water may be the drive time of the water pump 146 if the output of the water pump 146 is constant. Likewise, the data regarding the supplied amount of fuel may be the drive time of the fuel pump 128 if the output of the fuel pump 128 is constant. If these are the case, the process shown in FIG. 4 and FIG. 10 will be as follows. Specifically, in Step S13, the drive time of the water pump 128 is obtained, in Step S15 a first drive time of the fuel pump 128 is obtained, and in Step S33 a second drive time of the fuel pump 128 is obtained. In Step S15, the drive time of the fuel pump 128 may be obtained based on the amount of the water supplied.

By using the pump drive time as described, it is possible to obtain the data regarding the amount of the supplied water or fuel easily and accurately.

It should be noted here that the fuel cell system according to the preferred embodiments of the present invention is applicable not only to motorbikes but also to any transportation equipment such as automobiles, marine vessels, etc.

In each of the preferred embodiments given above, description was made for a case where methanol is used as the fuel, and aqueous methanol solution is used as the aqueous fuel solution. However, the present invention is not limited to these preferred embodiments, and the fuel may be provided by other alcohol based fuels such as ethanol, and the aqueous fuel solution may be provided by an aqueous solution of the alcohol, such as aqueous ethanol solution.

Also, the present invention is applicable to stationary type fuel cell systems as long as a liquid fuel is used. Further, the present invention is applicable to portable type fuel cell systems for electronic devices such as personal computers and mobile electronic devices.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fuel cell system comprising:
a fuel cell;
an aqueous solution container arranged to hold and supply aqueous fuel solution to the fuel cell;
a water supplying device arranged to supply the aqueous solution container with water;
a fuel supplying device arranged to supply the aqueous solution container with fuel;
a water supply amount obtaining device arranged to obtain data regarding an amount of water supplied by the water supplying device to the aqueous solution container; and
a controller arranged to control the fuel supplying device based on the data regarding the supplied amount of water obtained by the water supply amount obtaining device.

2. The fuel cell system according to claim 1, further comprising a first fuel-supply amount obtaining device arranged to obtain data regarding a supplied amount of fuel to the aqueous solution container based on the data regarding the supplied amount of water obtained by the water supply amount obtaining device, wherein the controller controls the fuel supplying device based on the data regarding the supplied amount of fuel obtained by the first fuel-supply amount obtaining device.

3. The fuel cell system according to claim 2, further comprising a second fuel-supply amount obtaining device arranged to obtaining data regarding a supplied amount of fuel to the aqueous solution container based on information regarding the concentration of the aqueous fuel solution; wherein the controller controls the fuel supplying device based on the data regarding the supplied amount of fuel obtained by the first fuel-supply amount obtaining device and the data regarding the supplied amount of fuel obtained by the second fuel-supply amount obtaining device.

4. The fuel cell system according to claim 3, further comprising:
a concentration detector arranged to detect a concentration of the aqueous fuel solution; and
a determination device arranged to determine whether or not a detection result by the concentration detector is reliable; wherein
the second fuel-supply amount obtaining device obtains the data regarding the supplied amount of fuel based on a detection result by the concentration detector if the determination device determines that the result of detection by the concentration detector is reliable.

5. The fuel cell system according to claim 4, further comprising a consumption amount obtaining device arranged to obtain a consumption amount of the fuel in the fuel cell; wherein the second fuel-supply amount obtaining device obtains the data regarding the supplied amount of fuel based on a consumption amount of the fuel obtained by the consumption amount obtaining device if the determination device determines that the detection result by the concentration detector is not reliable.

6. The fuel cell system according to claim 4, further comprising:
a temperature detector arranged to detect a temperature of the aqueous fuel solution; and
a time measuring device arranged to measure a time from a start of power generation in the fuel cell; wherein
the determination device determines whether or not a result of detection by the concentration detector is reliable based on a result of detection by the temperature detector and a result of time measurement by the time measuring device.

7. The fuel cell system according to claim 1, wherein the water supplied by the water supplying device to the aqueous solution container is produced by an electrochemical reaction in the fuel cell.

8. The fuel cell system according to claim 7, further comprising a water container arranged to hold the water from the fuel cell; wherein the water supplying device supplies the aqueous solution container with the water held in the water container.

9. The fuel cell system according to claim 1, wherein the data regarding the supply amount of the water includes a drive time of the water supplying device.

10. The fuel cell system according to claim 1, further comprising a first liquid amount detector arranged to detect an amount of liquid in the aqueous solution container; wherein the water supply amount obtaining device obtains the data regarding the supplied amount of water based on a result of detection by the first liquid amount detector.

11. The fuel cell system according to claim 10, wherein the first liquid amount detector detects the amount of liquid in the aqueous solution container based on a level of the liquid surface in the aqueous solution container.

12. The fuel cell system according to claim 8, further comprising a second liquid amount detector arranged to detect an amount of liquid in the water container; wherein the water supply amount obtaining device obtains the data regarding the supplied amount of water based on a result of detection by the second liquid amount detector.

13. The fuel cell system according to claim 1, further comprising a first liquid amount detector arranged to detect an amount of liquid in the aqueous solution container; wherein the controller controls the water supplying device so as to supply the water when a result of detection by the first liquid amount detector is lower than a first predetermined amount, and controls the fuel supplying device based on the data regarding the supplied amount of water when the result of detection by the first liquid amount detector is lower than the first predetermined amount.

14. The fuel cell system according to claim 13, further comprising:
a water container arranged to hold the water from the fuel cell; and
a second liquid amount detector arranged to detect an amount of liquid in the water container; wherein
the controller controls the water supplying device so as to supply the water when a result of detection by the first liquid amount detector is lower than the first predetermined amount and a result of detection by the second liquid amount detector is not lower than a second predetermined amount.

15. Transportation equipment comprising the fuel cell system according to claim 1.
